(19) United States
(12) Patent Application Publication
(10) Pub. No.: US 2005/0158514 A1
(43) Pub. Date: Jul. 21, 2005

(54) Bodyboard

(76) Inventor: Henkel Lin, Taichung Hsien (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/759,049

(22) Filed: Jan. 20, 2004

(51) Int. Cl. B32B 3/10

(52) U.S. Cl. 428/138

(57) ABSTRACT

A bodyboard has a body and a protective strip. The body has a core, an upper layer and a lower layer. The core has a top, a bottom and multiple holes defined in the top and the bottom. The upper layer is securely attached to the top of the core with glue. The lower layer is securely attached to the bottom of the core with glue. The protective strip is mounted on the edge of the body along the front and two sides of the body. The holes in the core plate enlarge the glue contact area of the core, such that the structure between the core, the upper layer and the lower layer is strengthened.

### BACKGROUND OF THE INVENTION

1. Field of the Invention

The present invention relates to a bodyboard, and more particularly to a bodyboard that can be used to surf on waves or ride on snow, is lightweight and an enhanced structure strengthened by multiple layers.

2. Description of Related Art

Bodysurfing is an exciting and popular sport for people who like adventurous and exciting activities. A bodyboard provides a greater degree of control when body surfing on waves. Conventional bodyboards are often composed of multiple layers held together with glue and made of lightweight material.

Because glue is applied to the top or bottom surface of each layer, the strength between adjacent layers is limited. The layers easily separate from each other after a term of using, such that the useful life of the conventional bodyboard is short.

To overcome the shortcomings, the present invention provides a bodyboard to mitigate or obviate the aforementioned problems.

### SUMMARY OF THE INVENTION

The main objective of the invention is to provide a lightweight bodyboard an enhanced structure strengthened by layers of the bodyboard to prolong the useful life of the bodyboard. The bodyboard has a body and a protective strip. The body has a core, an upper layer and a lower layer. The core has a top, a bottom and multiple holes defined respectively in the top and the bottom. The upper layer is securely attached to the top of the core with glue. The lower layer is securely attached to the bottom of the core plate with glue. The protective strip is mounted on the edge of the body along the front and two sides of the body. With the holes in the core plate, the contact area of the core plate with glue is enlarged, such that the combining strength between the core plate, upper layer and the lower layer is enhanced.

Other objects, advantages and novel features of the invention will become more apparent from the following detailed description when taken in conjunction with the accompanying drawings.

### BRIEF DESCRIPTION OF THE DRAWINGS

FIG. 1 is a perspective view of a bodyboard in accordance with the present invention;

FIG. 2 is an exploded perspective view of the bodyboard in FIG. 1; and

FIG. 3 is a cross sectional side plan view of the bodyboard in FIG. 1.

### DETAILED DESCRIPTION OF PREFERRED EMBODIMENT

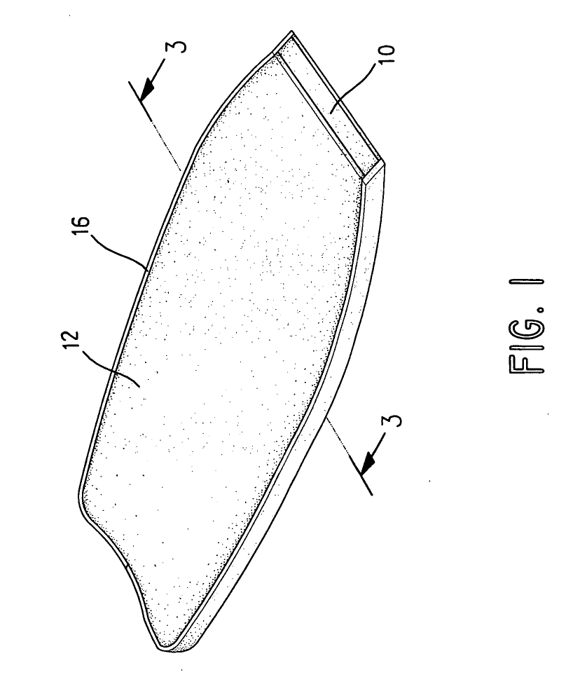

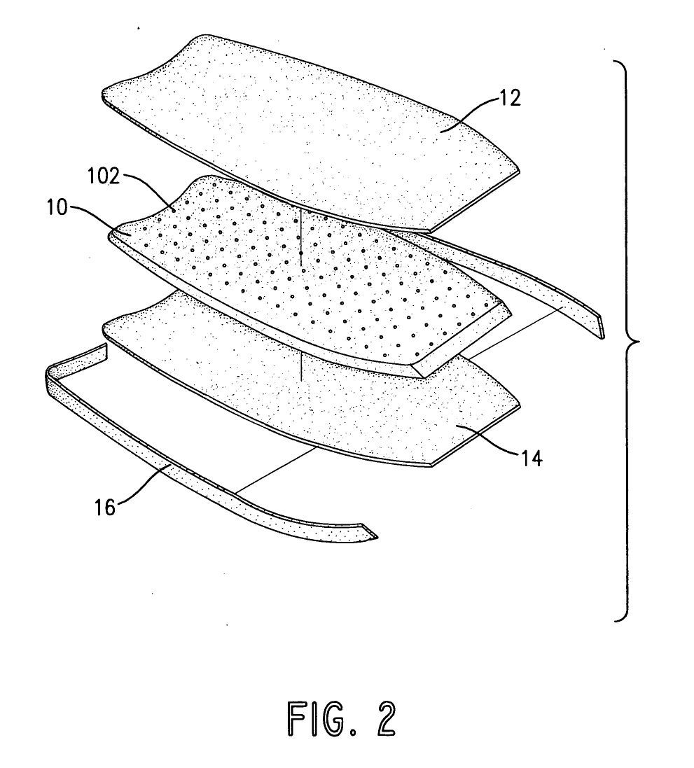

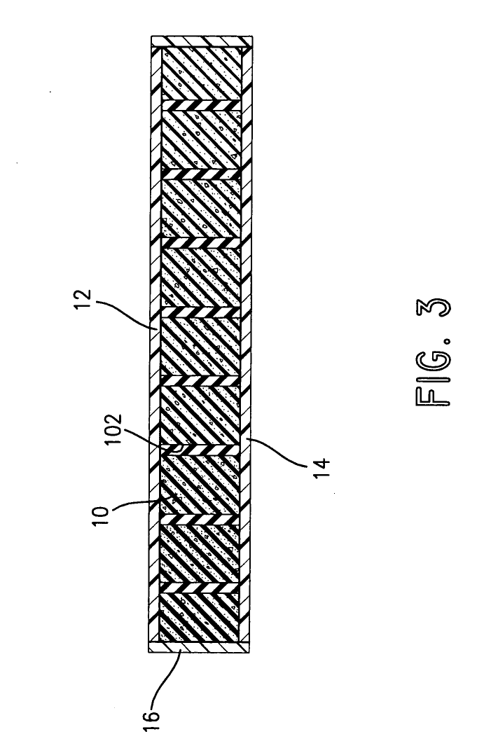

With reference to FIGS. 1 to 3, a bodyboard in accordance with the present invention comprises a body (not numbered) and a protective strip (not numbered). The body has an edge (not numbered) with a front (not numbered), a rear (not numbered) and two sides (not numbered) and comprises a core (10), an upper layer (12) and a lower layer (14). Each layer of the body is made of a lightweight material the bodyboard will float on water. The core (10) has a shape, a top (not numbered), a bottom (not numbered) and multiple holes (102) defined in the top and the bottom. In a preferred embodiment, each hole (102) is a through hole defined through the core (10) from the top to the bottom. The core (10) can be made of a material selected from one of a group consisting of epoxy resin, expandable polystyrene (EPS), expandable polypropylene (EPP) and expandable polyethylene (EPE).

The upper layer (12) is securely attached to the top of the core plate (10) with glue and has a shape substantially the same as that of the core (10). The upper layer (12) can be made of a foaming material selected from one of a group consisting of crosslinked polyethylene, ethylene-vinyl acetate copolymer foam (EVA foam), polypropylene foam (PP foam) and polyethylene foam (PE foam).

The lower layer (14) is securely attached to the bottom of the core plate (10) with glue and has a shape substantially the same as that of the core (10). The lower layer (14) can be made of a material selected from one of a group consisting of polypropylene (PP) and polyethylene (PE).

The protective strip is mounted on the edge of the body along the front and two sides. The protective strip is securely attached to the edge of the body with glue. In a preferred embodiment, the protective strip is made of the same material as the upper layer (12). In an optional embodiment, the protective strip comprises two protective strip segments (16) mounted respectively on the sides of the body and extending to and abutting at the front of the body. In an alternative embodiment, the protective strip is a single protective strip.

In such an arrangement, the holes (102) in the core (10) enlarge the contact area of and adhesive bond of the glue with the core (10), which strengthens the bond between the core plate (10), the upper layer (12) and the lower layer (14). Furthermore, the protective strip strengthens the layers of the body by covering the exposed joint at the edges of the body and protecting the exposed edges from bumps and wear. Therefore, the layers of the body will not easily separate from each other, and the useful life of the bodyboard is prolonged. Furthermore, the protective strip makes the appearance of the bodyboard aesthetically pleasing.

Even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

1. A bodyboard comprising:
a body with an edge with a front, a rear and two sides and comprising
a core having a top, a bottom and multiple holes defined in the top and the bottom;
an upper layer securely attached to the top of the core; and
a lower layer securely attached to the bottom of the core; and
a protective strip mounted on the edge of the body along the front and two sides of the body.

2. The bodyboard as claimed in claim 1, wherein each hole is a through hole defined through the core from the top to the bottom.

3. The bodyboard as claimed in claim 2, wherein the protective strip comprises two strip elements mounted respectively on the sides of the body and extending to and abutting at the front of the body.

4. The bodyboard as claimed in claim 3, wherein the upper layer is made of a foaming material selected from one of a group consisting of crosslinked polyethylene, ethylene-vinyl acetate copolymer foam, polypropylene foam and polyethylene foam.

5. The bodyboard as claimed in claim 4, wherein the protective strip is made of a foaming material the same as that of the upper layer.

6. The bodyboard as claimed in claim 3, wherein the core plate is made of a material selected from one of a group consisting of epoxy resin, expandable polystyrene (EPS), expandable polypropylene (EPP) and expandable polyethylene (EPE).

7. The bodyboard as claimed in claim 3, wherein the lower layer is made of a material selected from one of a group consisting of polypropylene (PP) and polyethylene (PE).

8. The bodyboard as claimed in claim 1, wherein the protective strip comprises two strip segments mounted respectively on the sides of the body and extending to abutting at the front of the body.
